(19) United States
(12) Patent Application Publication
(10) Pub. No.: US 2022/0245966 A1
(43) Pub. Date: Aug. 4, 2022

(54) IMAGE PROCESSING IN VEHICLE CABIN

(71) Applicant: Shanghai SenseTime Intelligent Technology Co., Ltd., Shanghai (CN)

(72) Inventors: Yangping WU, Shanghai (CN); Songya LOU, Shanghai (CN); Fei WANG, Shanghai (CN)

(21) Appl. No.: 17/724,978

(22) Filed: Apr. 20, 2022

Related U.S. Application Data
(63) Continuation of application No. PCT/CN2020/099998, filed on Jul. 2, 2020.

(30) Foreign Application Priority Data
Oct. 22, 2019 (CN) 201911008608.8

(51) Int. Cl. G06V 40/16; G06V 20/59; G06Q 30/02

(52) U.S. Cl. CPC G06V 40/172; G06V 40/161; G06Q 30/0265; G06V 40/168; G06V 20/597

(57) ABSTRACT

Methods, apparatuses, systems, and computer-readable storage media for processing cabin interior images of vehicles are provided. In one aspect, a method includes: acquiring a cabin interior image captured by an image capturing device positioned in a cabin of the vehicle, obtaining, for each of one or more faces involved in the cabin interior image, a face bounding box corresponding to the face by performing face detection on the cabin interior image, and determining, for each of one or more face bounding boxes, at least one of an identity attribute of a cabin interior person corresponding to the face bounding box or a position of the cabin interior person corresponding to the face bounding box in the cabin.

### CROSS REFERENCE TO RELATED APPLICATIONS

The present application is a continuation of International Application No. PCT/CN2020/099998, filed on Jul. 2, 2020, which claims priority to Chinese patent application No. 201911008608.8, filed on Oct. 22, 2019, the entire contents of which are incorporated herein by reference.

### TECHNICAL FIELD

The present disclosure relates to the field of computer technologies, and in particular, to methods and apparatuses for processing a cabin interior image.

### BACKGROUND

With the development of science and technology, vehicles have been gradually developed from conventional mechanical tools to a means of transportation with information and entertainment functions. In recent years, information of vehicles has been connected through a network, and vehicle surveillance videos can be retrieved through video surveillance, but information of persons in cabins of vehicle is not connected through the network. Even if information of a vehicle is retrieved from the surveillance videos, information of a cabin interior person cannot be retrieved.

### SUMMARY

The present disclosure provides a method and an apparatus for processing a cabin interior image for a vehicle.

In a first aspect, the present disclosure provides a method of processing a cabin interior image for a vehicle, including: acquiring a cabin interior image captured by an image capturing device positioned in a cabin of the vehicle; obtaining, for each of one or more faces involved in the cabin interior image, a face bounding box corresponding to the face by performing face detection on the cabin interior image; and determining, for each of one or more face bounding boxes, an identity attribute and/or a position in the cabin of a cabin interior person corresponding to the face bounding box.

According to the method of processing a cabin interior image for a vehicle, the face bounding box corresponding to each of the one or more faces is obtained by performing the face detection on the cabin interior image, and then the identity attribute and/or the position in a cabin of a cabin interior person corresponding to the face bounding box may be determined based on the face bounding box, without extracting face features, which is beneficial to reduce computation complexity and effectively improve efficiency of obtaining identity attribute information and position information of the cabin interior person through the cabin interior image.

In a second aspect, the present disclosure provides an apparatus for processing a cabin interior image for a vehicle, including: an acquiring module configured to acquire a cabin interior image captured by an image capturing device positioned in a cabin of the vehicle; a detecting module configured to obtain, for each of one or more faces involved in the cabin interior image, a face bounding box corresponding to the face by performing face detection on the cabin interior image; and a determining module configured to determine, for each of one or more face bounding boxes, at least one of an identity attribute or a position in the cabin of a cabin interior person corresponding to the face bounding box.

In a third aspect, the present disclosure provides a non-volatile computer readable storage medium having a computer program stored thereon, wherein the computer program is executed by hardware to implement the method according to the first aspect.

In a fourth aspect, the present disclosure provides a computer program product, wherein the computer program product is read and executed by a computer to implement the method according to the first aspect.

In a fifth aspect, the present disclosure provides a computer program, including: computer readable codes, wherein the computer readable codes, when running in an electronic device, are executed by a processor in the electronic device to implement the method according to the first aspect.

### BRIEF DESCRIPTION OF THE DRAWINGS

In order to explain technical solutions in embodiments of the present disclosure more clearly, drawings to be used in the description of the embodiments will be briefly introduced below. Obviously, the drawings in the following description are some embodiments of the present disclosure. For those of ordinary skill in the art, other drawings can be obtained based on these drawings without creative work.

FIG. 1 is a schematic flowchart illustrating a method of processing a cabin interior image for a vehicle according to one or more embodiments of the present disclosure.

FIG. 2 is a schematic diagram illustrating a face bounding box and an image coordinate system according to one or more embodiments of the present disclosure.

FIG. 3 is a schematic diagram illustrating possible identity attributes and positions of cabin interior persons according to one or more embodiments of the present disclosure.

FIG. 4 is a schematic diagram illustrating a first preset region and a second preset region according to one or more embodiments of the present disclosure.

FIG. 5 is a schematic diagram illustrating display of a face bounding box and/or a detection result according to one or more embodiments of the present disclosure.

FIG. 6 is a schematic diagram illustrating display control on a face bounding box and/or a detection result according to one or more embodiments of the present disclosure.

FIG. 7 is a schematic structural diagram illustrating an apparatus for processing a cabin interior image for a vehicle according to one or more embodiments of the present disclosure.

FIG. 8 is a schematic structural diagram illustrating another apparatus for processing a cabin interior image for a vehicle according to one or more embodiments of the present disclosure.

FIG. 9 is a schematic structural diagram illustrating another apparatus for processing a cabin interior image for a vehicle according to one or more embodiments of the present disclosure.

### DETAILED DESCRIPTION OF THE EMBODIMENTS

The technical solutions in the embodiments of the present disclosure will be clearly and completely described with reference to the drawings therein. Obviously, the described embodiments are part but not all the embodiments of the present disclosure. Based on the embodiments of the present disclosure, all other embodiments obtained by those of ordinary skill in the art without creative work shall fall within the protection scope of the present disclosure.

It should be understood that terms “including” and “comprising”, when being used in the specification and the appended claims, indicate existence of described features, wholes, steps, operations, elements and/or components, but do not exclude existence or addition of one or more other features, wholes, steps, operations, elements, components and/or combinations thereof.

It should also be understood that terms used in the specification of the present disclosure are only for the purpose of describing specific embodiments and are not intended to limit the present disclosure. As used in the specification and the appended claims of the present disclosure, singular forms “a”, “an” and “the” are intended to include plural forms unless otherwise clearly indicated in the context.

It should be further understood that a term “and/or” used in the specification and the appended claims of the present disclosure refers to any combination and all possible combinations of one or more associated listed items, and inclusion of these combinations.

To begin with, FIG. 1 is a schematic flowchart illustrating a method of processing a cabin interior image for a vehicle provided by the present disclosure. The method may include the following steps S101 to S103.

At S101, a cabin interior image captured by an image capturing device positioned in a cabin of the vehicle is acquired.

In a possible example, the image capturing device positioned in the cabin of the vehicle is used to collect information of the cabin interior in real time and capture the cabin interior image. The captured cabin interior image can involve picture information of a plurality of pictures collected at consecutive timings, or video information of a video of a certain length such as 10 seconds, etc., which is not specifically limited herein. An apparatus for processing a cabin interior image for a vehicle can acquire cabin interior images in real time or at a preset time interval, which is not specifically limited herein.

In practical applications, the image capturing device can be an analog camera or a smart camera, such as an infrared camera, which has advantages of long night vision distance, strong concealment and stable performance, etc. and can ensure that image information of the cabin interior can be collected normally during the day and at night to acquire a cabin interior image. The cabin may be a five-seater cabin or a seven-seater cabin, and the cabin may be a left-hand drive cabin or a right-hand drive cabin, which is not specifically limited herein.

At S102, face detection is performed on the cabin interior image to obtain a face bounding box for each of one or more faces involved in the cabin interior image.

The cabin interior image on which the face detection is performed may include one or more faces. Cabin interior person(s) corresponding to the one or more faces may be a person sitting in a front-row seat or a rear-row seat of the cabin. The face of a cabin interior person may have ornaments, and the cabin interior person may be male or female, which is not specifically limited herein. Because there are many possibilities for face information of the cabin interior person, face information in the cabin interior image captured by the image capturing device can also be various, such as a frontal face, or a side face with a certain angle deflection, or an adult face, or a child face, which is not specifically limited herein.

In a possible example, before performing the face detection on the cabin interior image, the image capturing device can be positioned according to a vehicle type and/or actual needs, so that the cabin interior image captured by the image capturing device positioned in the cabin can include a face image of any cabin interior person as possible, regardless of whether the cabin interior person is sitting in a front-row seat, a middle-row seat or a rear-row seat in the cabin. Therefore, it is necessary to predetermine the position of the image capturing device in the cabin. In the present disclosure, the image capturing device may be positioned close to the front of the cabin with a lens oriented toward the rear of the cabin. For example, the image capturing device is positioned on a rear-view mirror, a navigator provided in the cabin, or near a display screen at a front end of the cabin, which is not specifically limited herein.

As can be known from the above solution, the image capturing device is positioned close to the front of the cabin with a lens oriented toward the rear of the cabin, which is convenient for comprehensively collecting cabin interior person information in the cabin to prepare for subsequent face detection.

Before performing the face detection on the cabin interior image captured by the image capturing device, the image can be preprocessed to eliminate adverse effects caused by problems such as uneven lighting and different angles. For example, first, face detection is performed on an input cabin interior image using a Haar feature cascade classifier to position eyes and obtain a binocular distance and a binocular inclination angle; and then a two-dimensional affine transformation is performed using this angle to rotate the face and eliminate the effect of different angles; afterwards, luminance normalization is performed using histogram equalization, and noises are eliminated using a smoothing process to realize a balance face illumination. After the preprocessing, a cabin interior image with relatively uniform face characteristics is obtained to prepare for the subsequent face detection.

In a possible example, a face detection algorithm can be used to perform the face detection on the cabin interior image to obtain a face bounding box including a face region in the cabin interior image. The face bounding box is used to indicate a position of a face. The face bounding box can be a rectangular box. Position information of the face bounding box includes a length and a width of the face bounding box and coordinates of any vertex of the face bounding box in an image coordinate system. For example, if there are four people involved in the cabin interior image, four rectangular boxes can be obtained, which respectively frame face regions of the four people. The face detection algorithm can be OpenFace, Deformable Partmodel (DMP), Cascade CNN, Densebox, etc., which is not specifically limited herein.

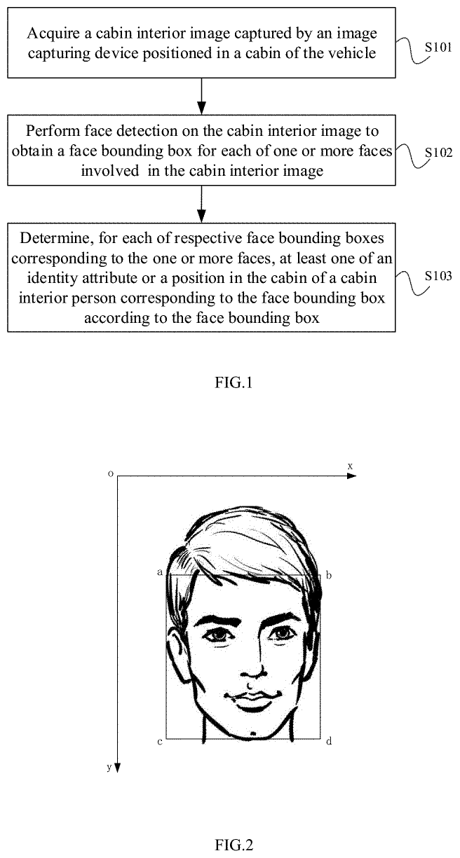

FIG. 2 is a schematic diagram illustrating a face bounding box and an image coordinate system provided by the present disclosure. For example, in FIG. 2, a cabin interior image involves a face, and face detection is performed on the cabin interior image to obtain coordinates of face bounding boxes a, b, c, d in an image coordinate system xoy.

At S103, for each of respective face bounding boxes corresponding to the one or more faces, at least one of an identity attribute or a position in the cabin of a cabin interior person corresponding to the face bounding box may be determined according to the face bounding box.

It is determined that the identity attribute of the cabin interior person corresponding to each of the face bounding boxes indicates at least one of: a driver, a passenger, a front-row seating person, a rear-row seating person, a middle-row seating person, a driver seating person, a co-driver seating person, or a non-driver seating person. It is determined that the position in the cabin of the cabin interior person corresponding to each of the face bounding boxes is in at least one of: a front-row seat, a rear-row seat, a middle-row seat, a driver seat, a co-driver seat, or a non-driver seat. In an example, at least one of an identity attribute or a position in the cabin of a cabin interior person corresponding to the face bounding box represents at least one of an identity attribute of a cabin interior person corresponding to the face bounding box or a position of the cabin interior person corresponding to the face bounding box in the cabin.

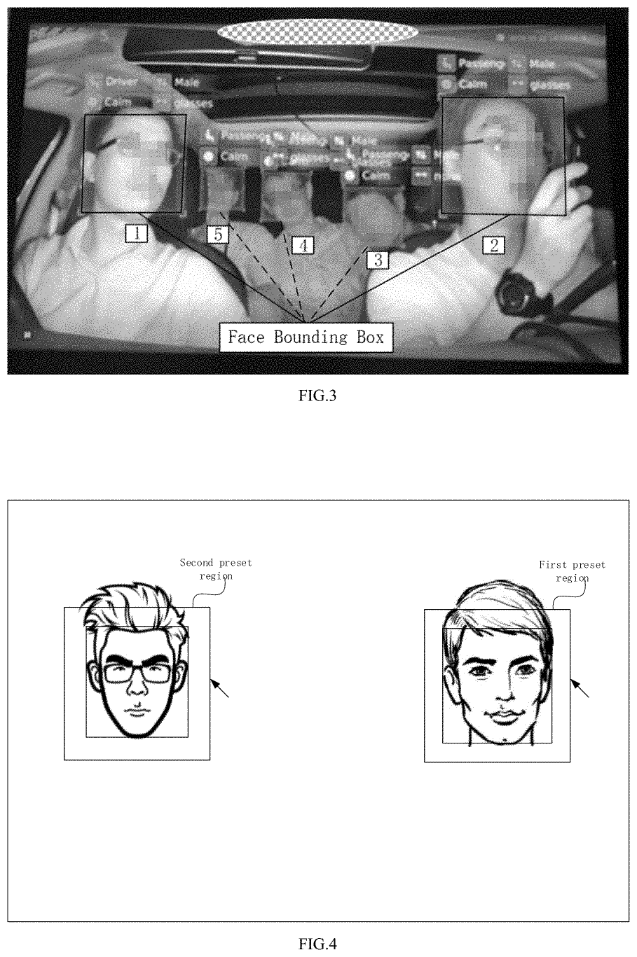

FIG. 3 is a schematic diagram illustrating possible identity attributes and positions of cabin interior persons provided by an embodiment of the present disclosure. In FIG. 3, five rectangular boxes involving face regions displayed in a cabin interior image are face bounding box 1, face bounding box 2, face bounding box 3, face bounding box 4 and face bounding box 5 obtained by performing detection on the cabin interior image. As can be seen from FIG. 3, face bounding box 1 and face bounding box 2 have larger areas than face bounding box 3, face bounding box 4 and face bounding box 5. That is to say, in the cabin interior image, face bounding box 1 and face bounding box 2 have larger area proportions than that of face bounding box 3, face bounding box 4 and face bounding box 5. In addition, as can be seen from FIG. 3, face bounding box 1 and face bounding box 2 are located near left and right sides in the cabin interior image, and face bounding box 3, face bounding box 4 and face bounding box 5 are located near a middle region in the cabin interior image.

Therefore, in the present disclosure, the identity attribute and/or the position of the cabin interior person corresponding to respective face bounding boxes in the cabin can be determined according to a difference between the respective face bounding boxes. As shown in FIG. 3, according to the difference between face bounding box 1, face bounding box 2, face bounding box 3, face bounding box 4 and face bounding box 5, it can be determined that an identity attribute of a cabin interior person corresponding to face bounding box 1 is a driver, and the cabin interior person corresponding to face bounding box 1 is in a driver seat in front-row seats; an identity attribute of a cabin interior person corresponding to face bounding box 2 is a passenger, and the cabin interior person corresponding to face bounding box 2 is in a co-driver seat in the front-row seats; identity attributes of cabin interior persons corresponding to face bounding box 3, face bounding box 4 and face bounding box 5 are passengers, and the cabin interior persons corresponding to face bounding box 3, face bounding box 4 and face bounding box 5 are in rear-row seats, i.e., non-driver seats.

Next, the process of determining the identity attribute and/or the position in the cabin of the cabin interior person corresponding to each face bounding box according to the face bounding box corresponding to the at least one face in the step S103 will be elaborated.

In a possible example, determining the identity attribute and/or the position in the cabin of the cabin interior person corresponding to each face bounding box according to the face bounding box corresponding to the at least one face may include the following steps.

At A1, area information of a face bounding box is determined.

In a possible example, through the step S102, a face bounding box for each of one or more faces involved in the cabin interior image can be obtained. That is, position information of the face bounding box is obtained, for example, coordinates of four vertices a, b, c, d of the face bounding box. After the position information of the face bounding box is obtained, area information of the face bounding box can be obtained. The area information of the face bounding box includes at least one of: an area of the face bounding box, or an area proportion of the face bounding box to the cabin interior image.

At A2, for any one of at least one face bounding box, the identity attribute and/or the position in the cabin of the cabin interior person corresponding to the face bounding box may be determined according to the area information of the face bounding box.

In a possible example, determining, according to the area information of the face bounding box, the identity attribute and/or the position in the cabin of the cabin interior person corresponding to the face bounding box may include: comparing preset area threshold information with the area information of the face bounding box, and then determining, according to a comparison result, the identity attribute and/or the position in the cabin of the cabin interior person corresponding to the face bounding box. The preset area threshold information includes: a preset area threshold, or a preset area proportion threshold.

In a possible example, under a premise that the cabin interior image is an image captured by the image capturing device positioned in the cabin close to the front of the vehicle with a lens oriented toward the rear of the vehicle, the identity attribute and/or the position in the cabin of the cabin interior person corresponding to the face bounding box may be determined according to the comparison result of the preset area threshold information with the area information of the face bounding box, which includes one or more of the following cases.

In response to determining that a ratio of the preset area threshold to the area of the face bounding box is less than a first preset threshold, and the cabin includes two rows of front and rear seats, one or more of following operations are performed: determining that the identity attribute of the cabin interior person corresponding to the face bounding box is the front-row seating person, and determining that the position of the cabin interior person corresponding to the face bounding box is in the front-row seat of the cabin.

Here, taking the first preset threshold being 1.5 and the preset area threshold being 3 cm² as an example, if an area of a face bounding box is 2.4 cm², the ratio of the preset area threshold to the area of the face bounding box is 1.25, which is less than the first preset threshold 1.5. It can be determined that the identity attribute of the cabin interior person corresponding to the face bounding box is the front-row seating person, and/or the position of the cabin interior person corresponding to the face bounding box is in the front-row seat of the cabin.

In a case that the ratio of the preset area threshold to the area of the face bounding box is greater than or equal to the first preset threshold, and the cabin includes two rows of front and rear seats, one or more of the following operations are performed: determining that the identity attribute of the cabin interior person corresponding to the face bounding box is the rear-row seating person, and determining that the position of the cabin interior person corresponding to the face bounding box is in the rear-row seat of the cabin.

Here, still taking the first preset threshold being 1.5 and the preset area threshold being 3 cm² as an example, if an area of a face bounding box is 1.6 cm², the ratio of the preset area threshold to the area of the face bounding box is 1.875, which is greater than the first preset threshold 1.5. It can be determined that the identity attribute of the cabin interior person corresponding to the face bounding box is the rear-row seating person, and/or the position of the cabin interior person corresponding to the face bounding box is in the rear-row seat of the cabin.

In a case where the ratio of the preset area threshold to the area of the face bounding box is less than a second preset threshold, and the cabin includes three rows of front, middle and rear seats, one or more of the following operations are performed: determining that the identity attribute of the cabin interior person corresponding to the face bounding box is the front-row seating person, and determining that the position of the cabin interior person corresponding to the face bounding box is in the front-row seat of the cabin.

In a case where the ratio of the preset area threshold to the area of the face bounding box is greater than or equal to the second preset threshold and less than a third preset threshold, and the cabin includes three rows of front, middle and rear seats, one or more of the following operations are performed: determining that the identity attribute of the cabin interior person corresponding to the face bounding box is the middle-row seating person, and determining that the position of the cabin interior person corresponding to the face bounding box is in the middle-row seat of the cabin.

In a case where the ratio of the preset area threshold to the area of the face bounding box is greater than or equal to the third preset threshold, and the cabin includes three rows of front, middle and rear seats, one or more of the following operations are performed: determining that the identity attribute of the cabin interior person corresponding to the face bounding box is the rear-row seating person, and determining that the position of the cabin interior person corresponding to the face bounding box is in the rear-row seat of the cabin.

For a cabin with front, middle and rear three rows of seats, the process of determining the identity attribute and/or the position of the cabin interior person corresponding to each face bounding box in the cabin is similar to that for the cabin with front and rear two rows of seats, which will not be repeated herein.

In the above examples, the preset threshold 1.5, the preset face area 3 cm², and the detected areas of face bounding boxes 2.4 cm² and 1.6 cm² are only an example of embodiments of the present disclosure, which are convenient for those skilled in the art to understand the present disclosure, and should not be regarded as a limitation to the embodiments of the present disclosure. In another possible implementation, under the premise that the cabin interior image is the image captured by the image capturing device that is positioned in the cabin close to the front of the vehicle with the lens oriented toward the rear of vehicle, the identity attribute and/or the position in the cabin of the cabin interior person corresponding to the face bounding box may be determined according to a comparison result of the preset area proportion threshold in the preset area threshold information with the area proportion of the face bounding box to the cabin interior image, which includes one or more of the following cases.

In a case where a ratio of the preset area proportion threshold to the area proportion of the face bounding box to the cabin interior image is less than a fourth preset threshold, and the cabin includes two rows of front and rear seats, one or more of the following operations are performed: determining that the identity attribute of the cabin interior person corresponding to the face bounding box is the front-row seating person, and determining that the position of the cabin interior person corresponding to the face bounding box is in the front-row seat of the cabin.

In a case where the ratio of the preset area proportion threshold to the area proportion of the face bounding box to the cabin interior image is greater than or equal to the fourth preset threshold, and the cabin includes two rows of front and rear seats, one or more of the following operations are performed: determining that the identity attribute of the cabin interior person corresponding to the face bounding box is the rear-row seating person, and determining that the position of the cabin interior person corresponding to the face bounding box is in the rear-row seat of the cabin.

In a case where the ratio of the preset area proportion threshold to the area proportion of the face bounding box to the cabin interior image is less than a fifth preset threshold, and the cabin includes three rows of front, middle and rear seats, one or more of the following operations are performed: determining that the identity attribute of the cabin interior person corresponding to the face bounding box is the front-row seating person, and determining that the position of the cabin interior person corresponding to the face bounding box is in the front-row seat of the cabin.

In a case where the ratio of the preset area proportion threshold to the area proportion of the face bounding box to the cabin interior image is greater than or equal to the fifth preset threshold and less than a sixth preset threshold, and the cabin includes three rows of front, middle and rear seats, one or more of the following operations are performed: determining that the identity attribute of the cabin interior person corresponding to the face bounding box is the middle-row seating person, and determining that the position of the cabin interior person corresponding to the face bounding box is in the middle-row seat of the cabin.

In a case where the ratio of the preset area proportion threshold to the area proportion of the face bounding box to the cabin interior image is greater than or equal to the sixth preset threshold, and the cabin includes three rows of front, middle and rear seats, one or more of the following operations are performed: determining that the identity attribute of the cabin interior person corresponding to the face bounding box is the rear-row seating person, and determining that the position of the cabin interior person corresponding to the face bounding box is in the rear-row seat of the cabin.

Here, before determining the identity attribute and/or the position of the cabin interior person according to the comparison result of the preset area threshold information with the area information of the face bounding box, the preset area threshold information, the first preset threshold, the second preset threshold or other preset thresholds need to be predetermined. The determination of the preset area threshold information, the first preset threshold, the second preset threshold or other preset thresholds is related to the arranging position of the image capturing device. Therefore, the cabin interior image on which the face detection is performed is an image captured by the image capturing device that is positioned in the cabin close to the front of the vehicle with the lens oriented toward the rear of the vehicle. Further, a transverse center of capturing image by the image capturing device can be oriented near a middle position of two front-row seats in the cabin, and a vertical direction of the capturing image can cause captured faces of cabin interior persons close to a center of the captured image as possible. After the image capturing device is positioned, the preset area threshold information, the first preset threshold, the second preset threshold or other preset thresholds can be determined.

The preset area threshold can be understood as a preset driver face area, and the preset area threshold can be a pre-stored face area, such as an area of a pre-synthesized face or an area of a preset face.

Here, taking the preset area threshold being the area of a preset face as an example, a driver can be preset as sifting in the driver seat of a vehicle, and a face box of the preset driver can be selected in the cabin interior image. The face box of the preset driver can be a face bounding box determined by performing face detection on the cabin interior image, or a face box including a preset driver face region in the cabin interior image which is selected by inputting instructions via a mouse or a keyboard. The face box is configured with coordinate information. According to the coordinate information of the face box, a length and a width of the face box can be calculated, so that a face area of the preset driver involved in the image, i.e., the preset area threshold, can be further calculated. Then, a preset area proportion threshold, i.e., a ratio of the preset area threshold to a cabin interior image area, can be calculated according to the preset area threshold.

After the preset area threshold and the preset area proportion threshold are obtained, the preset area threshold and the preset area proportion threshold are stored to a configuration file, and then the first preset threshold, the second preset threshold or other preset thresholds can be configured in the configuration file.

Specifically, in the case where the cabin includes two rows of front and rear seats, only the first preset threshold needs to be configured. The first preset threshold represents a preset ratio of face areas in front and rear rows. In the case where the cabin includes three rows of front, middle and rear seats, the second preset threshold and the third preset threshold need to be configured. The second preset threshold represents a preset ratio of face areas in front and middle rows, and the third preset threshold represents a preset ratio of face areas in front and rear rows. For different types of vehicles, a distance between the image capturing device and the front seats in the cabin may be the same as that between the image capturing device and the rear seats in the cabin. Therefore, the first preset threshold and the third preset threshold may be same, which is not specifically limited herein. Processes of configuring the fourth preset threshold, the fifth preset threshold and the sixth preset threshold are similar to that of configuring the first preset threshold, the second preset threshold and the third preset threshold, which will not be repeated herein.

In practical applications, there may be one or more pre-selected drivers, which is not specifically limited herein. In the case of one pre-selected driver, a calculated preset driver face area in the image is the preset area threshold. In the case of a plurality of pre-selected drivers, an average value of a plurality of calculated preset driver face areas is the preset area threshold. The preset area threshold may be obtained by other calculation methods, which is not specifically limited herein.

As can be known from the above solution, according to the present disclosure, the area information of respective face bounding boxes can be determined through face detection technologies, and then for the cabin interior person corresponding to each of the respective face bounding boxes, the identity attribute (is the front-row seating person, the middle-row seating person or the rear-row seating person in the cabin) and/or the position (is in the front-row seat, the middle-row seat or the rear-row seat of the cabin) of the cabin interior person can be determined according to the comparison result of the preset area threshold information with the area information of the face bounding box, with neither acquiring information from traditional human analysis on a surveillance video nor extracting face features. Therefore, it is beneficial to reduce computation complexity, effectively save human and material resources, time, etc., and improve work efficiency.

In a possible example, under the premise that the cabin interior image is an image captured by the image capturing device that is positioned in the cabin with the lens oriented toward the rear of the vehicle and close to the front of the vehicle, for any one of one or more face bounding boxes, the identity attribute and/or the position in the cabin of the cabin interior person corresponding to the face bounding box can be determined according to relative position information of the face bounding box. This determining manner includes one or more of the following cases.

In a case where a relative position of the face bounding box is within a first preset region, one or more of the following operations are performed: determining that the identity attribute of the cabin interior person corresponding to the face bounding box is the driver seating person, and determining that the position of the cabin interior person corresponding to the face bounding box is in the driver seat of the cabin.

In a case where the relative position of the face bounding box is within a second preset region, one or more of the following operations are performed: determining that the identity attribute of the cabin interior person corresponding to the face bounding box is the co-driver seating person, and determining that the position of the cabin interior person corresponding to the face bounding box is in the co-driver seat of the cabin.

In a case where the relative position of the face bounding box is outside the first preset region and the second preset region, one or more of the following operations are performed: determining that the identity attribute of the cabin interior person corresponding to the face bounding box is the non-driver seating person, and determining that the position of the cabin interior person corresponding to the face bounding box is in the non-driver seat of the cabin.

The determination of the first preset region and the second preset region is also related to the position of arranging the image capturing device. Therefore, the position of the image capturing device needs to be predetermined. In practical applications, for different types of vehicles, the driver seat in the cabin can be either a left seat or a right seat in front seats of the cabin. Therefore, it is necessary to adjust the position of the image capturing device for different types of vehicles. Generally, the image capturing device is positioned in the cabin with a lens oriented toward the rear of the vehicle and close to the front of the vehicle. For example, a transverse center of capturing image by the image capturing device can be oriented near a middle position of two front-row seats in the cabin, and a vertical direction of the capturing image can cause captured faces of cabin interior persons close to a center of the captured image as possible. After the image capturing device is positioned in the cabin, the first preset region and the second preset region can be further determined.

As can be known from the above solution, according to the present disclosure, the relative position information of respective face bounding boxes can be determined through face detection technologies, and then for the cabin interior person corresponding to each of the respective face bounding boxes, the identity attribute (is the driver seating person, the co-driver seating person or the non-driver seating person) and/or the position (is in the driver seat, the co-driver seat or the non-driver seat) of the cabin interior person can be determined according to the relative position information of the respective face bounding boxes, with neither acquiring information from traditional human analysis on a surveillance video nor extracting face features. Therefore, it is beneficial to reduce computation complexity, effectively save human and material resources, time, etc., and improve work efficiency.

In a possible example, the process of determining the first preset region and the second preset region may be:

At B1, position information of a preset driver face box and a preset co-driver face box is determined, and the preset driver face box and the preset co-driver face box are displayed in the cabin interior image.

Determining the position information of the preset driver face box and the preset co-driver face box may include, for example, a driver can be preset as sitting in the driver seat of a vehicle, and a co-driver can be preset as sitting in the co-driver seat of the vehicle. In this way, a preset driver face and a preset co-driver face can be displayed in the cabin interior image, and then the preset driver face box and the preset co-driver face box can be selected from the cabin interior image. The preset driver face box and the preset co-driver face box can be face bounding boxes determined by performing face detection on the cabin interior image, or face boxes of the preset driver and the preset co-driver in the cabin interior image which are selected by inputting instructions on a display screen in the cabin via a mouse or a keyboard. The preset driver face box and the preset co-driver face box are face boxes with coordinates.

At B2, display control is performed on the first preset region and the second preset region according to a position of the preset driver face box and a position of the preset co-driver face box, and position information of the first preset region and the second preset region is stored to a configuration file.

According to the position of the preset driver face box and the position of the preset co-driver face box displayed through the display screen in the cabin, the first preset region and the second preset region can be determined by inputting instructions on the display screen, and the position information of the first preset region and the second preset region can be stored to the configuration file.

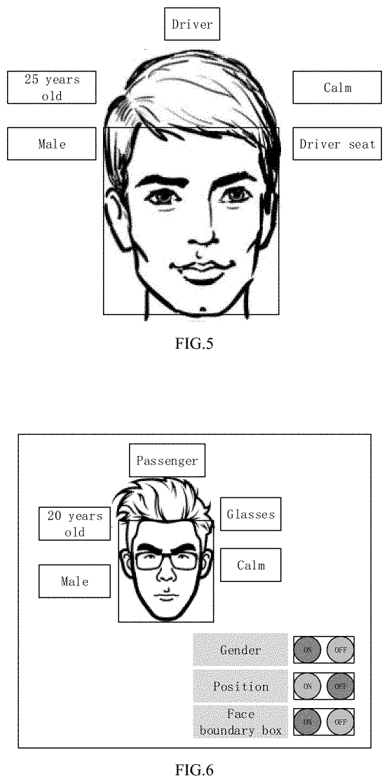

FIG. 4 is a schematic diagram illustrating a first preset region and a second preset region provided by the present disclosure. FIG. 4 shows positions of the first preset region and the second preset region. As can be seen from FIG. 4, the first preset region has an area larger than that of the preset driver face box, and the second preset region has an area larger than that of the preset co-driver face box. It can be understood that FIG. 4 is used only as an example. In practical applications, the areas of the first preset region and the second preset region may be larger or smaller, and the positions of the first preset region and the second preset region may be other positions, which are not specifically limited herein.

In a possible example, under the premise that the cabin interior image is an image captured by the image capturing device that is positioned in the cabin with a lens oriented toward the rear of the vehicle and close to the front of the vehicle, for any one of at least one face bounding box, the identity attribute and/or the position of the cabin interior person corresponding to the face bounding box in the cabin can be determined according to the area information of the face bounding box and the relative position information of the face bounding box in the cabin interior image, which includes one or more of the following cases.

In a case where a ratio of the preset area threshold to the area of the face bounding box is less than a first preset threshold, and a relative position of the face bounding box is within the first preset region, one or more of the following operations are performed: determining that the identity attribute of the cabin interior person corresponding to the face bounding box is the driver, and determining that the position of the cabin interior person corresponding to the face bounding box is in the driver seat of the cabin.

In a case where the ratio of the preset area threshold to the area of the face bounding box is less than the first preset threshold, and the relative position of the face bounding box is outside the first preset region, one or more of the following operations are performed: determining that the identity attribute of the cabin interior person corresponding to the face bounding box is the passenger, and determining that the position of the cabin interior person corresponding to the face bounding box is in the co-driver seat of the cabin.

In a case where the ratio of the preset area threshold to the area of the face bounding box is greater than or equal to the first preset threshold, and the relative position of the face bounding box is outside the first preset region, one or more of the following operations are performed: determining that the identity attribute of the cabin interior person corresponding to the face bounding box is the passenger, and determining that the position of the cabin interior person corresponding to the face bounding box is in the non-driver seat of the cabin.

In a possible example, under the premise that the cabin interior image is an image captured by the image capturing device that is positioned in the cabin with a lens oriented toward the rear of the vehicle and close to the front of the vehicle, for any one of at least one face bounding box, the identity attribute and/or the position of the cabin interior person corresponding to the face bounding box in the cabin can be further determined according to the area information of the face bounding box and the relative position information of the face bounding box in the cabin interior image, which includes one or more of the following cases.

In a case where a ratio of the preset area proportion threshold to the area proportion of the face bounding box in the cabin interior image is less than a fourth preset threshold, and a relative position of the face bounding box is within a first preset region, one or more of the following operations are performed: determining that the identity attribute of the cabin interior person corresponding to the face bounding box is the driver, and determining that the position of the cabin interior person corresponding to the face bounding box is in the driver seat of the cabin.

In a case where the ratio of the preset area proportion threshold to the area proportion of the face bounding box in the cabin interior image is less than the fourth preset threshold, and the relative position of the face bounding box is outside the first preset region, one or more of the following operations are performed: determining that the identity attribute of the cabin interior person corresponding to the face bounding box is the passenger, and determining that the position of the cabin interior person corresponding to the face bounding box is in the co-driver seat of the cabin.

In a case where the ratio of the preset area proportion threshold to the area proportion of the face bounding box in the cabin interior image is greater than or equal to the fourth preset threshold, and the relative position of the face bounding box is outside the first preset region, one or more of the following operations are performed: determining that the identity attribute of the cabin interior person corresponding to the face bounding box is the passenger, and determining that the position of the cabin interior person corresponding to the face bounding box is in the non-driver seat of the cabin.

As can be known from the above solution, according to the present disclosure, the area information and the relative position information of respective face bounding boxes can be determined through face detection technologies, and then for the cabin interior person corresponding to each of the respective face bounding boxes, the identity attribute (is the driver or the passenger) and/or the position (is in the driver seat, the co-driver seat or the non-driver seat) of the cabin interior person can be determined according to the area information and the relative position information of the face bounding box, with neither acquiring information from traditional human analysis on a surveillance video nor extracting face features. Therefore, it is beneficial to reduce computation complexity, effectively save human and material resources, time, etc., and improve work efficiency.

In a possible example, for each of obtained face bounding boxes corresponding to at least one face involved in the cabin interior image, feature extraction is performed on an image region corresponding to the face bounding box in the cabin interior image, and one or more face attributes of a cabin interior person corresponding to the face bounding box may be determined according to one or more extracted features. The face attributes may include a gender, an age, an emotional state, whether the cabin interior person wears a mask, whether the cabin interior person wears glasses, whether the cabin interior person is smoking, or whether the cabin interior person is a child. In practical applications, the extracted face attribute features can be stored, which facilitates speeding up retrieval for the next face detection performed on the same cabin interior person's face.

For example, the feature extraction can be performed on image regions corresponding to the respective face bounding boxes in the cabin interior image using a convolutional neural network. The convolutional neural network can be a network with a simple structure, for example, a small network with only 2 convolutional layers. Therefore, a face area and a face region of a person in the cabin interior image can be efficiently and accurately detected. Further, the convolutional neural network can be a complex network with 10 convolutional layers for detecting subtle face attributes such as an age and an expression of a person in the cabin interior image, which is not specifically limited herein. In addition, the convolutional neural network may be a Residual Network (ResNet), a VGG Network (VGGNet), etc., which is not specifically limited herein.

It can be seen that according to the present disclosure, the feature extraction can be performed on image regions corresponding to face bounding boxes in the cabin interior image, and face attributes of a cabin interior person corresponding to each of the face bounding boxes can be determined according to the extracted features. In this way, the value of video surveillance is deeply excavated, so as to effectively improve the efficiency of obtaining face attribute information of a cabin interior person through a cabin interior image.

In a possible example, the cabin interior image can be displayed through a display screen positioned in the cabin, and in a case where the face detection is performed on the cabin interior image, the one or more face bounding boxes and/or a detection result can be displayed in the cabin interior image. The detection result may include the identity attribute, the position, the face attributes, etc. of the cabin interior person corresponding to the face bounding box. FIG. 5 shows a possible example of displaying a face bounding box and/or a detection result. FIG. 5 shows a face bounding box, and an identity attribute, a position, an emotional state, a gender and an age in the detection result. It can be understood that FIG. 5 is used only as an example. In practical applications, the shown detection result may further include other or more contents, which is not specifically limited herein.

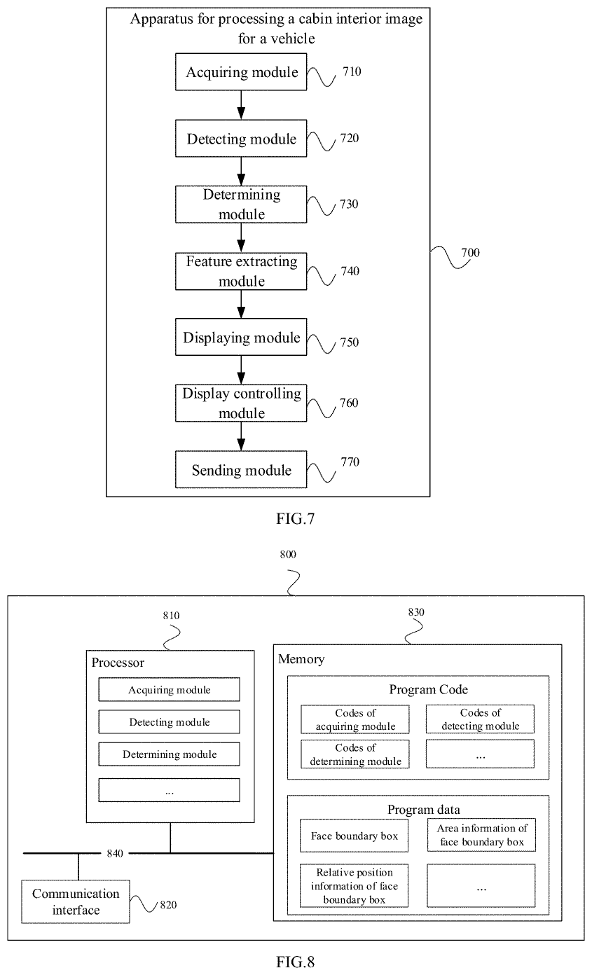

Further, display setting information of the one or more face bounding boxes and/or the detection result can be obtained through the display screen positioned in the cabin, and display control for the one or more face bounding boxes and/or the detection result may be performed on the cabin interior image according to the display setting information. FIG. 6 is a possible schematic diagram illustrating display control on a face bounding box and/or a detection result. FIG. 6 shows the display control on the face bounding box, the gender and the position, where the gender and the face bounding box are in a displaying state, and the position is in a non-displaying state. It can be understood that FIG. 6 is used only as an example. In practical applications, the display control may be display control on the one or more face bounding boxes and/or other detection results, which is not specifically limited herein.

According to the present disclosure, by showing the face bounding box and/or the detection result in the cabin interior image displayed on the display screen positioned in the cabin, the cabin interior person involved in the cabin interior image can be positioned quickly and thus information of the cabin interior person can be obtained without performing subjective analysis on a surveillance video. At the same time, the display control can be performed on the face bounding box and/or the detection result in the cabin interior image according to the display setting information to optimize user interactive experience.

In a possible example, according to the face attributes of cabin interior persons corresponding to respective face bounding boxes, advertisement information can be determined and then displayed on the display screen positioned in the cabin.

For example, an advertisement push list may be generated in advance by classifying the advertisement information according to an age, a gender and other attribute features of different persons. And then, for each of the face bounding boxes, one or more pieces of advertisement information matching the face attributes such as the gender or the age attribute of the cabin interior person can be retrieved, and the retrieved pieces of advertisement information can be sorted and played in sequence according to respective matching degrees. The matching degree can be set to be sorted according to gender relevance, age relevance or the like. For example, advertisements regarding cars, real estates, games or the like can be pushed to a male, and advertisements regarding food, beauty, clothing or the like can be pushed to a female. In addition, the advertisement information in the advertisement push list can be periodically updated.

In a possible example, according to an emotional state of at least one cabin interior person corresponding to respective face bounding boxes, predetermined prompt information can be determined and then displayed and/or played through the display screen positioned in the cabin.

For example, an apparatus for processing cabin interior image for a vehicle, when detecting that the emotional state of at least one cabin interior person corresponding to respective face bounding boxes is sad, angry, painful, crying, etc., can select predetermined prompt information matching the detected emotional state, and display as well as play the predetermined prompt information through the display screen positioned in the cabin. For example, children's programs or children's songs can be played for the crying emotion of a child, and soothing music can be played for the angry emotion of a female. In addition, the predetermined prompt information can be periodically updated.

In a possible example, the detection result of the face detection performed on the cabin interior image can be sent to a server, so that a relevant department or staff can quickly grasp detailed information of the cabin interior person, without manually viewing videos. For example, the detection result can be sent to a public security vehicle supervision system terminal through in-vehicle network communication in real time to prevent a vehicle from being stolen.

It can be seen that in the solution of the embodiments provided by the present disclosure, through the face detection performed on the cabin interior image captured by the image capturing device with face detection technologies, the face bounding box is obtained, and further, the area information and the relative position information of the face bounding box are determined. According to the area information and/or the relative position information of the face bounding box, the identity attribute of the cabin interior person corresponding to the face bounding box is determined, such as the driver, the passenger, the front-row seating person, the rear-row seating person or other identities, and further, the position in the cabin of the cabin interior person corresponding to the face bounding box is determined, such as the driver seat, the non-driver seat, the front-row seat, the middle-row seat or other positions. As can be known, according to the present disclosure, effective information can be fully excavated from a video surveillance system positioned in the cabin, without extracting face features, thereby greatly improving the efficiency of obtaining identity attribute information and position information of the cabin interior person through the cabin interior image. At the same time, according to the present disclosure, by performing the display control on the detected face bounding box and/or detection result such as face attributes, and providing more high-quality services to users using the detection result, the utilization value of the video surveillance system in the cabin is fully played.

The method of processing a cabin interior image for a vehicle according to the embodiment of the present disclosure is described above in detail. Based on the same inventive concept, an apparatus for processing a cabin interior image for a vehicle according to an embodiment of the present disclosure is provided below.

FIG. 7 is a schematic structural diagram illustrating an apparatus 700 for processing a cabin interior image for a vehicle provided by the present disclosure. The apparatus 700 includes at least an acquiring module 710, a detecting module 720 and a determining module 730. The acquiring module 710 is configured to acquire a cabin interior image captured by an image capturing device positioned in a cabin of the vehicle.

The detecting module 720 is configured to obtain, for each of one or more faces involved in the cabin interior image, a face bounding box corresponding to the face by performing face detection on the cabin interior image.

The determining module 730 is configured to determine, for each of respective face bounding boxes corresponding to the one or more faces, an identity attribute and/or a position in the cabin of a cabin interior person corresponding to the face bounding box according to the face bounding box.

In a possible example, under the premise that the cabin interior image is an image captured by the image capturing device that is positioned in the cabin with a lens oriented toward rear of vehicle and close to front of the vehicle, the determining module 730 is specifically configured to: for each of the one or more face bounding boxes, compare preset area threshold information with area information of the face bounding box, where the preset area threshold information includes a preset area threshold or a preset area proportion threshold; and determine, according to a comparison result and relative position information, the identity attribute and/or the position in the cabin of the cabin interior person corresponding to the face bounding box.

In a possible example, the image capturing device is an infrared camera positioned on a rear-view mirror in the cabin with a lens oriented toward a rear of the vehicle.

In a possible example, the apparatus 700 for processing a cabin interior image for a vehicle provided by the embodiment of the present disclosure may further include a feature extracting module 740, a displaying module 750 and a display controlling module 760.

The feature extracting module 740 is configured to perform, for each face bounding box, feature extraction on an image region corresponding to the face bounding box in the cabin interior image.

After features are extracted by the feature extracting module 740, face attributes of a cabin interior person corresponding to the face bounding box are determined by the determining module 730 according to the extracted features.

The displaying module 750 is configured to determine position information of a preset driver face box and a preset co-driver face box, and display the preset driver face box and the preset co-driver face box in the cabin interior image.

The display controlling module 760 is configured to perform display control on a first preset region and a second preset region according to a position of the preset driver face box and a position of the preset co-driver face box, and store position information of the first preset region and the second preset region to a configuration file.

In a possible example, the apparatus 700 for processing a cabin interior image for a vehicle provided by the embodiment of the present disclosure may further include a sending module 770 configured to send a detection result of the face detection performed on the cabin interior image to a server.

The functional modules of the apparatus for processing a cabin interior image for a vehicle can be used to implement the method described in the above method embodiments. For details, reference can be made to FIGS. 1 to 6 and description in relevant contents of corresponding method embodiments, which will not be repeated herein for simplicity of the specification.

According to the above solution, the detection can be performed on the cabin interior image to obtain one or more face bounding boxes, and the identity attribute and/or the position in the cabin of the cabin interior person corresponding to each of the one or more face bounding boxes can be determined according to the area information and/or the relative position information of the face bounding box, thereby effectively improving the efficiency of obtaining the information of the cabin interior person through the cabin interior image, and increasing the utilization value of the surveillance system in the cabin.

The apparatus 700 for processing a cabin interior image for a vehicle according to the present disclosure can be implemented in a single computing node or on a cloud computing infrastructure, which is not specifically limited herein. How to implement the apparatus 700 for processing a cabin interior image for a vehicle in a single computing node and on a cloud computing infrastructure will be respectively introduced below.

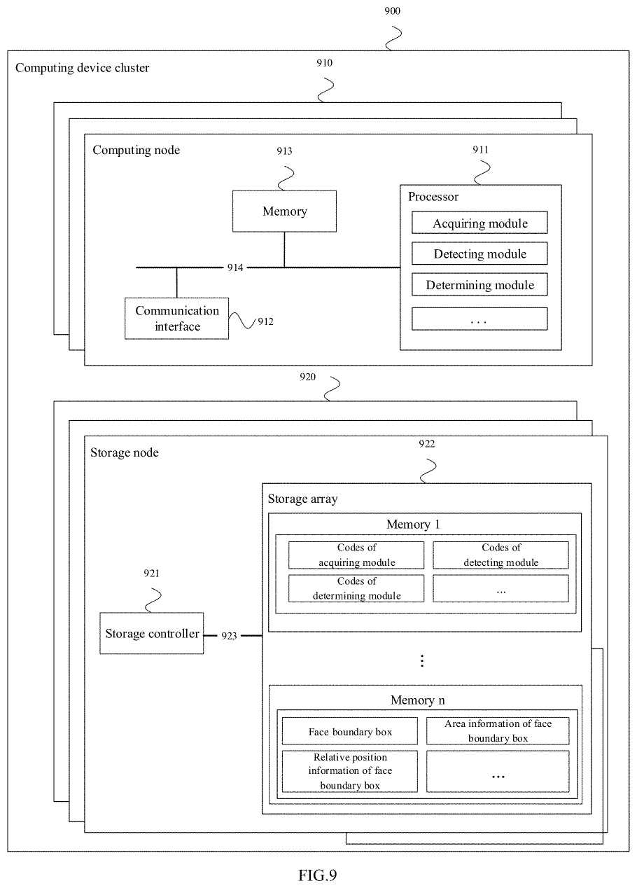

Referring to FIG. 8, the present disclosure provides a schematic structural diagram illustrating an apparatus for processing a cabin interior image for a vehicle according to another embodiment. The apparatus for processing a cabin interior image for a vehicle according to this embodiment can be implemented in a computer node 800 as shown in FIG. 8, including at least a processor 810, a communication interface 820 and a memory 830. The processor 810, the communication interface 820 and the memory 830 are coupled via a bus 840.

The processor 810 is used to run the acquiring module 710, the detecting module 720, the determining module 730, the feature extracting module 740, the displaying module 750, the display controlling module 760 and the sending module 770 in FIG. 7 by invoking program codes in the memory 830. In practical applications, the processor 810 may include one or more general-purpose processors, where the general-purpose processors may be any type of devices that can process electronic instructions, including a Central Processing Unit (CPU), a microprocessor, a microcontroller, a main processor, a controller, an Application Specific Integrated Circuit (ASIC) and so on. The processor 810 reads the program codes stored in the memory 830, and cooperates with the communication interface 820 to perform a part or all of steps in a method implemented by a cabin interior person position detecting device 400 in the embodiments of the present disclosure.

The communication interface 820 may be a wired interface (for example, an Ethernet interface) for communicating with other computing nodes or devices. When the communication interface 820 is the wired interface, the communication interface 820 may adopt a protocol family based on TCP/IP, such as an RAAS protocol, a Remote Function Call (RFC) protocol, a Simple Object Access Protocol (SOAP) protocol, a Simple Network Management Protocol (SNMP) protocol, a Common Object Request Broker Architecture (CORBA) protocol or a distributed protocol.

The memory 830 may store program codes and program data. The program codes include codes of the acquiring module 710, codes of the detecting module 720, codes of the determining module 730, codes of the feature extracting module 740, codes of the displaying module 750, codes of the display controlling module 760 and codes of the sending module 770. The program data includes: the detected face bounding box, the area information of the face bounding box, the relative position information of the face bounding box, the face attributes corresponding to the face bounding box, etc. In practical applications, the memory 830 may include a Volatile Memory, such as a Random Access Memory (RAM). The memory may also include a Non-Volatile Memory, such as a Read-Only Memory (ROM), a Flash Memory, a Hard Disk Drive (HDD), or a Solid-State Drive (SSD). The memory may also include a combination of the above types of memories.

Referring to FIG. 9, the present disclosure provides a schematic structural diagram illustrating an apparatus for processing a cabin interior image for a vehicle according to another embodiment. The apparatus for processing a cabin interior image for a vehicle according to this embodiment can be implemented in a computing device cluster 900 such as a cloud service cluster, including: at least one computing node 910 and at least one storage node 920.

The computing node 910 includes one or more processors 911, a communication interface 912 and a memory 913. The processors 911, the communication interface 912 and the memory 913 may be connected via a bus 914.

The processors 911 include one or more general-purpose processors, and are used to run the acquiring module 710, the detecting module 720, the determining module 730, the feature extracting module 740, the displaying module 750, the display controlling module 760 and the sending module 770 in FIG. 7 by invoking program codes in the memory 913, where the general-purpose processors can be any type of devices that can process electronic instructions, including a Central Processing Unit (CPU), a microprocessor, a microcontroller, a main processor, a controller, an Application Specific Integrated Circuit (ASIC) and so on. The general-purpose processors can be dedicated processors used only for the computing node 910 or can be shared with other computing nodes 910. The processors 911 read program codes stored in the memory 913, and cooperate with the communication interface 912 to perform a part or all of steps in a method implemented by a cabin interior person position detecting device 400 in the embodiments of the present disclosure.

The communication interface 912 may be a wired interface (for example, an Ethernet interface) for communicating with other computing nodes or users. When the communication interface 912 is the wired interface, the communication interface 912 may adopt a protocol family based on TCP/IP, such as an RAAS protocol, a Remote Function Call (RFC) protocol, a Simple Object Access Protocol (SOAP) protocol, a Simple Network Management Protocol (SNMP) protocol, a Common Object Request Broker Architecture (CORBA) protocol or a distributed protocol, etc.

The memory 913 may include a Volatile Memory, such as a Random Access Memory (RAM). The memory may also include a Non-Volatile Memory, such as a Read-Only Memory (ROM), a Flash Memory, a Hard Disk Drive (HDD), or a Solid-State Drive (SSD). The memory may also include a combination of the above types of memories.

The storage node 920 includes one or more storage controllers 921, and a storage array 922. The storage controllers 921 and the storage array 922 may be connected via a bus 923.

The storage controllers 921 include one or more general-purpose processors, where the general-purpose processors may be any type of devices that can process electronic instructions, including a CPU, a microprocessor, a microcontroller, a main processor, a controller, an ASIC and so on. The general-purpose processors can be dedicated processors used only for a single storage node 920 or can be shared with the computing node 900 or other storage nodes 920. It can be understood that in this embodiment, each storage node includes one storage controller. In other embodiments, a plurality of storage nodes may share one storage controller, which is not specifically limited herein.

The storage array 922 may include a plurality of memories. The memories may be non-volatile memories, such as ROMs, flash memories, HDDs or SSDs. The memories may also include a combination of the above types of memories. For example, the storage array may be composed of a plurality of HDDs or a plurality of SDDs, or the storage array may be composed of HDDs and SDDs. A plurality of memories are combined in different ways with the assistance of the storage controller 921 to form memory groups, thereby providing higher storage performance than a single memory and providing a data backup technology. Optionally, the storage array 922 may include one or more data centers. The plurality of data centers may be provided at the same location or at different locations, which is not specifically limited herein. The storage array 922 may store program codes and program data. The program codes include codes of the acquiring module 710, codes of the detecting module 720, codes of the determining module 730, codes of the feature extracting module 740, codes of the displaying module 750, codes of the display controlling module 760, and codes of the sending module 770. The program data includes: the detected face bounding box, the area information of the face bounding box, the relative position information of the face bounding box, the face attributes corresponding to the face bounding box, etc.

An embodiment of the present disclosure further provides a non-volatile computer readable storage medium having a computer program stored thereon, where the computer program is executed by hardware (such as a processor) to perform a part or all of steps in any method implemented by the apparatus for processing a cabin interior image for a vehicle in the embodiments of the present disclosure.

An embodiment of the present disclosure further provides a computer program product, where the computer program product is read and executed by a computer to cause the apparatus for processing a cabin interior image for a vehicle to perform a part or all of steps in the method of processing a cabin interior image for a vehicle in the embodiments of the present disclosure.

Those of ordinary skill in the art may be aware that units and algorithm steps in the examples described in the embodiments disclosed herein may be implemented in whole or in part by software, hardware, firmware or any combination thereof, and when being implemented by the software, they may be implemented in the form of a computer program product in whole or in part. The computer program product includes one or more computer instructions. When the computer program instructions are loaded and executed on a computer, procedures or functions according to the examples of the present application are generated in whole or in part. The computer may be a general-purpose computer, a special-purpose computer, a computer network or other programmable apparatuses. Computer instructions may be stored in a computer-readable storage medium, or transmitted from a computer-readable storage medium to another computer-readable storage medium. For example, the computer instructions may be transmitted from a website, computer, server or data center to another website, computer, server or data center in a wired manner such as a coaxial cable, an optical fiber and a digital subscriber line, or in a wireless manner such as infrared, radio and microwave. The computer-readable storage medium may be any available medium that may be accessed by a computer or a data storage device such as a server and a data center integrated with one or more available media. The available medium may be a magnetic medium such as a floppy disk, a hard disk and a magnetic tape, an optical medium such as a DVD, a semiconductor medium such as a Solid State Disk (SSD), etc. In the described embodiments, the description of each embodiment has its own emphasis. For parts that are not described in detail in an embodiment, reference can be made to related descriptions of other embodiments.

In several embodiments provided in the present disclosure, it should be understood that the disclosed apparatus may be implemented in other ways. The apparatus embodiments described above are only schematic. For example, the division of units is only the division of logical functions, and in actual implementation, there may be other division manners, for example, a plurality of units or components may be combined, or integrated into another system, or some features may be ignored, or not be implemented. In addition, the coupling or direct coupling or communication connection between displayed or discussed components may be through some interfaces, and the indirect coupling or communication connection between apparatuses or units may be electrical, mechanical or in other forms.

The units described as separate components may or may not be physically separated, and the components displayed as units may or may not be physical units, which may be located in one place or may be distributed to a plurality of network units. Some or all of the units may be selected according to actual needs to achieve the objectives of the present disclosure.

In addition, all functional units in the embodiments of the present disclosure may be integrated into one processing unit, or each unit may be present alone physically, or two or more units may be integrated into one unit. The integrated units may be implemented in the form of hardware, or in the form of software functional units.

The integrated units, if being implemented in the form of software functional units and sold or used as independent products, may be stored in a non-volatile computer readable storage medium. Based on this understanding, the technical solutions in the present disclosure in essence or a part thereof that contributes to the prior art or all or a part of the technical solutions may be embodied in the form of a software product. The computer software product is stored in a storage medium, including several instructions for enabling a computer device, which may be a personal computer, a server, a network device or the like, to perform all or a part of the methods described in the embodiments of the present disclosure. The storage medium includes a U disk, a mobile hard disk, a Read-Only Memory (ROM), a Random Access Memory (RAM), a magnetic disk or an optical disc, and other media that can store program codes.

The above are only the specific embodiments of the present disclosure, but the protection scope of this disclosure is not limited thereto. All equivalent changes or replacements that any person skilled in the art can readily envisage within the technical scope disclosed herein shall be contained in the protection scope of the disclosure. Therefore, the protection scope of the present disclosure shall be based on the protection scope of the claims.

1. A computer-implemented method, comprising:
acquiring a cabin interior image captured by an image capturing device positioned in a cabin of a vehicle;
obtaining, for each of one or more faces involved in the cabin interior image, a face bounding box corresponding to the face by performing face detection on the cabin interior image; and
determining, for each of one or more face bounding boxes, at least one of an identity attribute or a position in the cabin of a cabin interior person corresponding to the face bounding box.

2. The computer-implemented method according to claim 1, wherein the identity attribute of the cabin interior person corresponding to the face bounding box comprises at least one of:
a driver, a passenger, a front-row seating person, a rear-row seating person, a middle-row seating person, a driver seating person, a co-driver seating person, or a non-driver seating person.

3. The computer-implemented method according to claim 1, wherein the position of the cabin interior person corresponding to the face bounding box in the cabin comprises:
a position in at least one of: a front-row seat, a rear-row seat, a middle-row seat, a driver seat, a co-driver seat, or a non-driver seat.

4. The computer-implemented method according to claim 1, wherein determining, for each of one or more face bounding boxes, at least one of an identity attribute or a position in the cabin of a cabin interior person corresponding to the face bounding box comprises:
for each of the one or more face bounding boxes,
determining area information of the face bounding box, wherein the area information comprises at least one of an area of the face bounding box or an area proportion of the face bounding box to the cabin interior image; and
determining, according to the area information of the face bounding box, the at least one of the identity attribute or the position in the cabin of the cabin interior person corresponding to the face bounding box.

5. The computer-implemented method according to claim 4, wherein the cabin interior image comprises an image captured by the image capturing device that is positioned in the cabin with a lens oriented toward a rear of the vehicle and close to a front of the vehicle, and
wherein determining, according to the area information of the face bounding box, the at least one of the identity attribute or the position in the cabin of the cabin interior person corresponding to the face bounding box comprises:
comparing preset area threshold information with the area information of the face bounding box, wherein the preset area threshold information comprises at least one of a preset area threshold or a preset area proportion threshold; and
determining, according to a comparison result, the at least one of the identity attribute or the position in the cabin of the cabin interior person corresponding to the face bounding box.

6. The computer-implemented method according to claim 5, wherein determining, according to a comparison result, the at least one of the identity attribute or the position in the cabin of the cabin interior person corresponding to the face bounding box comprises at least one of:
in response to determining that a ratio of the preset area threshold to the area of the face bounding box is less than a first preset threshold and that the cabin comprises two rows of front and rear seats, determining at least one of: the identity attribute of the cabin interior person corresponding to the face bounding box is a front-row seating person, or the position of the cabin interior person corresponding to the face bounding box is in a front-row seat of the cabin;
in response to determining that the ratio of the preset area threshold to the area of the face bounding box is greater than or equal to the first preset threshold and that the cabin comprises the two rows of front and rear seats, determining at least one of: the identity attribute of the cabin interior person corresponding to the face bounding box is a rear-row seating person, or the position of the cabin interior person corresponding to the face bounding box is in a rear-row seat of the cabin;
in response to determining that the ratio of the preset area threshold to the area of the face bounding box is less than a second preset threshold and that the cabin comprises three rows of front, middle and rear seats, determining at least one of: the identity attribute of the cabin interior person corresponding to the face bounding box is a front-row seating person, or the position of the cabin interior person corresponding to the face bounding box is in a front-row seat of the cabin;
in response to determining that the ratio of the preset area threshold to the area of the face bounding box is greater than or equal to the second preset threshold and less than a third preset threshold and that the cabin comprises the three rows of front, middle and rear seats, determining at least one of: the identity attribute of the cabin interior person corresponding to the face bounding box is a middle-row seating person, or the position of the cabin interior person corresponding to the face bounding box is in a middle-row seat of the cabin; or
in response to determining that the ratio of the preset area threshold to the area of the face bounding box is greater than or equal to the third preset threshold and that the cabin comprises the three rows of front, middle and rear seats, determining at least one of: the identity attribute of the cabin interior person corresponding to the face bounding box is a rear-row seating person, or the position of the cabin interior person corresponding to the face bounding box is in a rear-row seat of the cabin.

7. The computer-implemented method according to claim 5, wherein determining, according to a comparison result, the at least one of the identity attribute or the position in the cabin of the cabin interior person corresponding to the face bounding box comprises at least one of:
in response to determining that a ratio of the preset area proportion threshold to the area proportion of the face bounding box to the cabin interior image is less than a fourth preset threshold and that the cabin comprises two rows of front and rear seats, determining at least one of: the identity attribute of the cabin interior person corresponding to the face bounding box is a front-row seating person, or the position of the cabin interior person corresponding to the face bounding box is in a front-row seat of the cabin;
in response to determining that the ratio of the preset area proportion threshold to the area proportion of the face bounding box to the cabin interior image is greater than or equal to the fourth preset threshold, and the cabin comprises the two rows of front and rear seats, determining at least one of: the identity attribute of the cabin interior person corresponding to the face bounding box is a rear-row seating person, or the position of the cabin interior person corresponding to the face bounding box is in a rear-row seat of the cabin;
in response to determining that the ratio of the preset area proportion threshold to the area proportion of the face bounding box to the cabin interior image is less than a fifth preset threshold and that the cabin comprises three rows of front, middle and rear seats, determining at least one of: the identity attribute of the cabin interior person corresponding to the face bounding box is a front-row seating person, or the position of the cabin interior person corresponding to the face bounding box is in a front-row seat of the cabin;
in response to determining that the ratio of the preset area proportion threshold to the area proportion of the face bounding box to the cabin interior image is greater than or equal to the fifth preset threshold and less than a sixth preset threshold and that the cabin comprises the three rows of front, middle and rear seats, determining at least one of: the identity attribute of the cabin interior person corresponding to the face bounding box is a middle-row seating person, or the position of the cabin interior person corresponding to the face bounding box is in a middle-row seat of the cabin; or
in response to determining that the ratio of the preset area proportion threshold to the area proportion of the face bounding box to the cabin interior image is greater than or equal to the sixth preset threshold and that the cabin comprises the three rows of front, middle and rear seats, determining at least one of: the identity attribute of the cabin interior person corresponding to the face bounding box is a rear-row seating person, or the position of the cabin interior person corresponding to the face bounding box is in a rear-row seat of the cabin.

8. The computer-implemented method according to claim 1, wherein determining, for each of one or more face bounding boxes, at least one of an identity attribute or a position in the cabin of the cabin interior person corresponding to the face bounding box comprises:
determining relative position information of each of the one or more face bounding boxes in the cabin interior image; and
for each of the one or more face bounding boxes, determining, according to the relative position information of the face bounding box, the at least one of the identity attribute or the position in the cabin of the cabin interior person corresponding to the face bounding box.

9. The computer-implemented method according to claim 8, wherein the cabin interior image is an image captured by the image capturing device that is positioned in the cabin with a lens oriented toward rear of the vehicle and close to a front of the vehicle, and
wherein determining, according to the relative position information of the face bounding box, the at least one of the identity attribute or the position in the cabin of the cabin interior person corresponding to the face bounding box comprises at least one of:
in response to determining that a relative position of the face bounding box is within a first preset region, determining at least one of: the identity attribute of the cabin interior person corresponding to the face bounding box is a driver seating person, or the position of the cabin interior person corresponding to the face bounding box is in a driver seat of the cabin;
in response to determining that the relative position of the face bounding box is within a second preset region, determining at least one of: the identity attribute of the cabin interior person corresponding to the face bounding box is a co-driver seating person, or the position of the cabin interior person corresponding to the face bounding box is in a co-driver seat of the cabin; or
in response to determining that the relative position of the face bounding box is outside the first preset region and the second preset region, determining at least one of: the identity attribute of the cabin interior person corresponding to the face bounding box is a non-driver seating person, or the position of the cabin interior person corresponding to the face bounding box is in a non-driver seat of the cabin.

10. The computer-implemented method according to claim 1, wherein determining, for each of one or more face bounding boxes, at least one of an identity attribute or a position in the cabin of the cabin interior person corresponding to the face bounding box comprises:
for each of the one or more bounding boxes,
determining area information of the face bounding box and relative position information of the face bounding box in the cabin interior image, wherein the area information comprises at least one of an area of the face bounding box in the cabin interior image or an area proportion of the face bounding box to the cabin interior image; and
determining, according to the area information and the relative position information of the face bounding box, the at least one of the identity attribute or the position in the cabin of the cabin interior person corresponding to the face bounding box.

11. The computer-implemented method according to claim 10, wherein the cabin interior image is an image captured by the image capturing device that is positioned in the cabin with a lens oriented toward rear of the vehicle and close to a front of the vehicle, and
wherein determining, according to the area information and the relative position information of the face bounding box, the at least one of the identity attribute or the position in the cabin of the cabin interior person corresponding to the face bounding box comprises:
for each of the one or more face bounding boxes,
comparing preset area threshold information with the area information of the face bounding box, wherein the preset area threshold information comprises: a preset area threshold or a preset area proportion threshold; and
determining, according to a comparison result and the relative position information, the at least one of the identity attribute or the position in the cabin of the cabin interior person corresponding to the face bounding box.

12. The computer-implemented method according to claim 11, wherein the determining, according to a comparison result and the relative position information, the at least one of the identity attribute or the position in the cabin of the cabin interior person corresponding to the face bounding box comprises at least one of:
in response to determining that a ratio of the preset area threshold to the area of the face bounding box is less than a first preset threshold and that a relative position of the face bounding box is within a first preset region, determining at least one of: the identity attribute of the cabin interior person corresponding to the face bounding box is a driver, or the position of the cabin interior person corresponding to the face bounding box is in a driver seat of the cabin;
in response to determining that the ratio of the preset area threshold to the area of the face bounding box is less than the first preset threshold and that the relative position of the face bounding box is outside the first preset region, determining at least one of: the identity attribute of the cabin interior person corresponding to the face bounding box is a passenger, or the position of the cabin interior person corresponding to the face bounding box is in ae co-driver seat of the cabin; or
in response to determining that the ratio of the preset area threshold to the area of the face bounding box is greater than or equal to the first preset threshold and that the relative position of the face bounding box is outside the first preset region, determining at least one of: the identity attribute of the cabin interior person corresponding to the face bounding box is a passenger, or the position of the cabin interior person corresponding to the face bounding box is in a non-driver seat of the cabin.

13. The computer-implemented method according to claim 11, wherein the determining, according to a comparison result and the relative position information, the at least one of the identity attribute or the position in the cabin of the cabin interior person corresponding to the face bounding box comprises at least one of:
in response to determining that a ratio of the preset area proportion threshold to the area proportion of the face bounding box in the cabin interior image is less than a fourth preset threshold and that a relative position of the face bounding box is within a first preset region, determining at least one of: the identity attribute of the cabin interior person corresponding to the face bounding box is a driver, or the position of the cabin interior person corresponding to the face bounding box is in a driver seat of the cabin;
in response to determining that the ratio of the preset area proportion threshold to the area proportion of the face bounding box in the cabin interior image is less than the fourth preset threshold, and the relative position of the face bounding box is outside the first preset region, determining at least one of: the identity attribute of the cabin interior person corresponding to the face bounding box is a passenger, or the position of the cabin interior person corresponding to the face bounding box is in a co-driver seat of the cabin; or
in response to determining that the ratio of the preset area proportion threshold to the area proportion of the face bounding box in the cabin interior image is greater than or equal to the fourth preset threshold and that the relative position of the face bounding box is outside the first preset region, determining at least one of: the identity attribute of the cabin interior person corresponding to the face bounding box is a passenger, or the position of the cabin interior person corresponding to the face bounding box is in a non-driver seat of the cabin.

14. The computer-implemented method according to claim 1, wherein the image capturing device is an infrared camera positioned on a rear-view mirror in the cabin with a lens oriented toward rear of the vehicle.

15. The computer-implemented method according to claim 1, further comprising:
determining position information of a preset driver face box and a preset co-driver face box, and displaying the preset driver face box and the preset co-driver face box in the cabin interior image; and
performing display control on a first preset region and a second preset region according to a position of the preset driver face box and a position of the preset co-driver face box in the cabin interior image, and storing position information of the first preset region and the second preset region to a configuration file.

16. The computer-implemented method according to claim 1, further comprising: after obtaining the one or more face bounding boxes corresponding to the one or more faces involved in the cabin interior image,
for each of the face bounding boxes in the cabin interior image,
performing feature extraction on an image region corresponding to the face bounding box; and
determining, according to one or more extracted features, face attributes of the cabin interior person corresponding to the face bounding box, wherein the face attributes comprise at least one of: a gender, an age, an emotional state, whether the cabin interior person wears a mask, whether the cabin interior person wears glasses, whether the cabin interior person is smoking, or whether the cabin interior person is a child.

17. The computer-implemented method according to claim 1, further comprising:
displaying the cabin interior image through a display screen positioned in the cabin, and
in response to performing the face detection on the cabin interior image, displaying at least one of the one or more face bounding boxes or a detection result in the cabin interior image.

18. The computer-implemented method according to claim 1, further comprising at least one of:
acquiring display setting information of at least one of the one or more face bounding boxes or a detection result, and performing, according to the display setting information, display control for the at least one of the one or more face bounding boxes or the detection result in the cabin interior image;
determining advertisement information according to face attributes of the cabin interior person corresponding to each of the one or more face bounding boxes, and displaying the advertisement information on a display screen positioned in the cabin;
determining predetermined prompt information according to an emotional state of the cabin interior person corresponding to each of the one or more face bounding boxes, and displaying or playing the predetermined prompt information through a display screen positioned in the cabin;
or
sending a detection result of the face detection performed on the cabin interior image to a server.

19. An apparatus, comprising:
at least one processor; and
one or more non-transitory memories coupled to the at least one processor and storing programming instructions for execution by the at least one processor to:
acquire a cabin interior image captured by an image capturing device positioned in a cabin of a vehicle;
obtain, for each of one or more faces involved in the cabin interior image, a face boundary box corresponding to the face by performing face detection on the cabin interior image; and
determine, for each of one or more face boundary boxes, at least one of an identity attribute or a position in the cabin of a cabin interior person corresponding to the face boundary box.

20. A non-transitory computer-readable storage medium coupled to at least one processor having machine-executable instructions stored thereon that, when executed by the at least one processor, cause the at least one processor to perform operations comprising:
acquiring a cabin interior image captured by an image capturing device positioned in a cabin of a vehicle;
obtaining, for each of one or more faces involved in the cabin interior image, a face bounding box corresponding to the face by performing face detection on the cabin interior image; and
determining, for each of one or more face bounding boxes, at least one of an identity attribute or a position in the cabin of a cabin interior person corresponding to the face bounding box.
